(19) United States
(12) Patent Application Publication
(10) Pub. No.: US 2004/0209596 A1
(43) Pub. Date: Oct. 21, 2004

(54) System and method for tracking financial transactions and merchandise purchases

(76) Inventors: Tony W. Wong, Dallas, TX (US); Alfred L. Chow, Plano, TX (US); Charlie Martin, Richardson, TX (US)

Correspondence Address: CARR LAW FIRM, L.L.P., 670 FOUNDERS SQUARE, 900 JACKSON STREET, DALLAS, TX, 75202, US

(21) Appl. No.: 10/841,914

(22) Filed: May 7, 2004

Related U.S. Application Data
(63) Continuation of application No. 09/557,553, filed on Apr. 25, 2000.

(51) Int. Cl. H04M 11/00

(52) U.S. Cl. 455/405

(57) ABSTRACT

A method for tracking events such as financial transactions, the status of merchandise orders, and the like, whereby, upon receipt of data describing at least one aspect of an event, at least one wireless receiver is identified to send at least a portion of the data to. The data is sent via a wireless communication network for transmission to the at least one wireless receiver.

### CROSS-REFERENCE TO RELATED APPLICATIONS

This application is a continuation of copending U.S. patent application Ser. No. 09/557,553 filed Apr. 25, 2000, entitled “System and Method for Tracking Financial Transactions and Merchandise Purchases.”

### TECHNICAL FIELD

The invention relates generally to tracking events and, more particularly, to a system and method for tracking financial transactions, the status of merchandise orders, and the like, using wireless or wireline communications.

### BACKGROUND

Credit cards, debit cards, long distance calling cards, Automated Teller Machine (ATM) cards, (hereinafter referred to as “commerce cards”), bank checks, and the like, are popular because they greatly facilitate and simplify financial transactions. Commerce cards are, furthermore, becoming invaluable for facilitating e-commerce.

Unfortunately, because commerce cards so greatly facilitate and simplify financial transactions, they are often stolen and unauthorized uses of them are made without the authorized owners of them even being aware of such uses. Unauthorized use of commerce cards may also occur unintentionally, for example, as when a number of a credit card number is not correctly transcribed by a waiter at a restaurant. For purposes of e-commerce, it is not even necessary for an unauthorized user to possess a commerce card, but merely to know the number and expiration date of a card, to commit fraudulent and unauthorized use of a card. To more fully appreciate the gravity of commerce card fraud, it is estimated that in 1997 alone, for example, worldwide losses due only to credit card fraud exceeded one billion dollars, and such fraud is expected to continue to increase with the anticipated growth of e-commerce.

Many strategies have been attempted to detect and/or prevent fraudulent unauthorized use of commerce cards. For example, the issuers of the cards have implemented hot lines that card holders can call to report lost cards and potential or real fraudulent use of cards. Card issuers may also monitor a card holder's usage and/or patterns of using a commerce card, and identify irregular usages and patterns which may be indicative of fraudulent usage. Card issuers may also implement “velocity tests” which identify indicia of fraudulent use when a card is used in a short period of time at two locations which are greatly separated geographically. A drawback with the foregoing attempts to detect and/or prevent fraudulent use of commerce cards is that they are generally not conclusive and, more importantly, often suffer from long delays before unauthorized usage is uncovered, during which delays such fraud may continue.

Another strategy used to deter unauthorized use of commerce cards has been to include a consumer's photograph on a commerce card. Two drawbacks with this strategy are that merchants often fail to check photos and, moreover, consumers have not been receptive to having their photographs included on commerce cards.

While commerce cards have become invaluable for facilitating e-commerce, as mentioned above, a drawback with e-commerce is that consumers must wait for purchased products to be shipped to them. While consumers are waiting, they typically do not know the status of their orders and/or goods as they are being handled and shipped. Similarly, when investors and traders transact orders, such as of stocks and bonds, they are often unaware of the status of their orders.

Accordingly, a continuing search has been directed to the development of methods which may be implemented to curb fraudulent unauthorized use of commerce cards, and which would also assist consumers in tracking the status of orders and the shipping of goods, as well as the status of investment orders.

### SUMMARY

The present invention, accordingly, provides a system and method which facilitates tracking events, such as financial transactions, the status of merchandise orders, and the like, whereby, upon receipt of data describing at least one aspect of an event, at least one wireless receiver is identified to send at least a portion of the data to. The data is sent via a wireless communication network for transmission to the at least one wireless receiver.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic diagram showing a system embodying features of the present invention;

FIG. 2 is a flow chart illustrating steps for implementing the present invention;

FIG. 3 is a schematic diagram showing the system of FIG. 1 adapted for e-commerce;

FIG. 4 is a schematic diagram showing the system of FIG. 1 wherein an account is accesses by the owner of the account;

FIG. 5 is a schematic diagram showing the system of FIG. 4 adapted for e-commerce;

FIG. 6 is a schematic diagram showing the system of FIG. 1 wherein a person has direct access to an account at a financial institution;

FIG. 7 is a schematic diagram showing the system of FIG. 6 adapted for e-commerce;

FIG. 8 is a schematic diagram showing the system of FIG. 7 wherein an account at the financial institution is accessed directly by the account owner;

FIG. 9 is a schematic diagram showing the system of FIG. 8 adapted for e-commerce;

FIG. 10 is a schematic diagram showing the system of FIGS. 1-5 adapted for alerting an account owner of various events that transpire to fill an order for merchandise; and

FIG. 11 is a schematic diagram showing the system of FIGS. 6-9 adapted for alerting an account owner of various events that transpire with respect to his/her account at a financial institution.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning commerce card transactions, e-commerce, wireless communications, and the like, have been omitted inasmuch as such details are not deemed necessary to obtain a complete understanding of the present invention, and are within the skills of persons of ordinary skill in the relevant art.

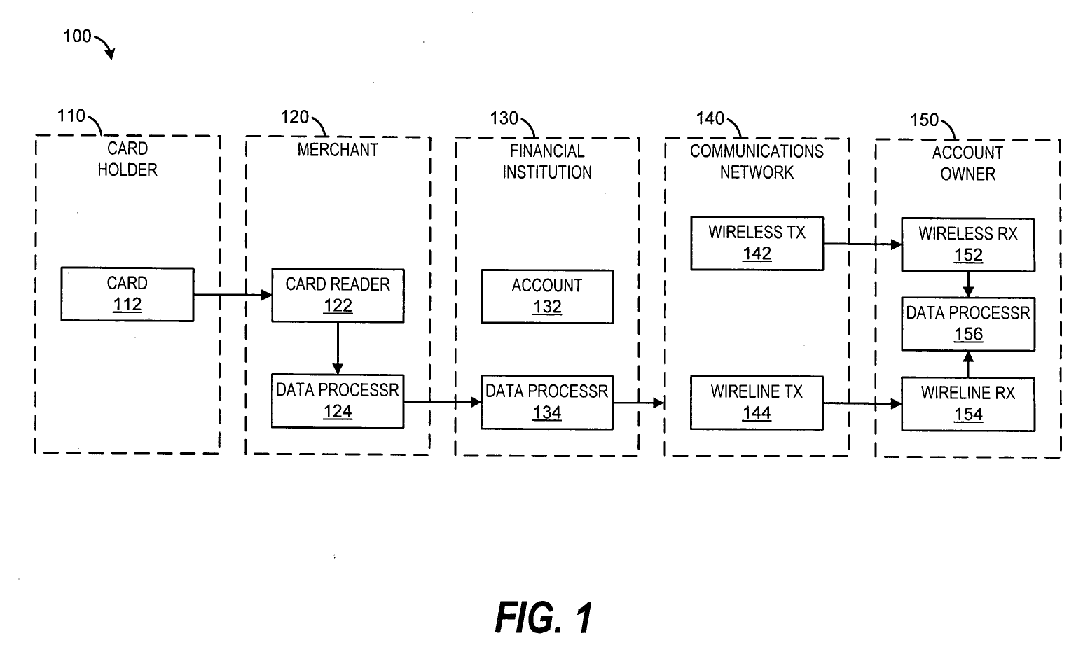

Referring to FIG. 1 of the drawings, the reference numeral 100 generally designates a system embodying features of the present invention. The system 100 includes a card holder 110, a merchant 120, a financial institution 130 of a account owner 150, and a communications network 140.

The card holder 110 may be a person or organization who holds, with or without authorization, a card 112 such as a credit card, debit card, long distance calling card, bank draft, bank check, or the like (hereinafter referred to as “commerce card” not shown), which draws on an account 132, discussed below. Authorized card holders 110 may include persons such as a family member (e.g., spouse or child of the account owner 150), a business associate of the account owner 150, or the like. Account information such as a card number (e.g., the account number 132), card expiration date, and the like, may be embedded on the commerce card 112 in a conventional manner, such as by magnetic encoding, bar coding, or the like.

The merchant 120 may be a retailer, manufacturer, provider, or the like, of merchandise. The term “merchandise” is generally used herein to include consumer goods and services and the like, although it is not necessarily limited to consumer goods and services. The merchant 120 has a conventional card reader 122, such as a magnetic code reader, bar code scanner, or the like, effective for reading data imprinted on the card 112, presented to the merchant 120 during a merchandise transaction. The card reader 122 is connected to at least one electronic data processor 124, such as a conventional computer, for receiving data read from the card 112, as described further below.

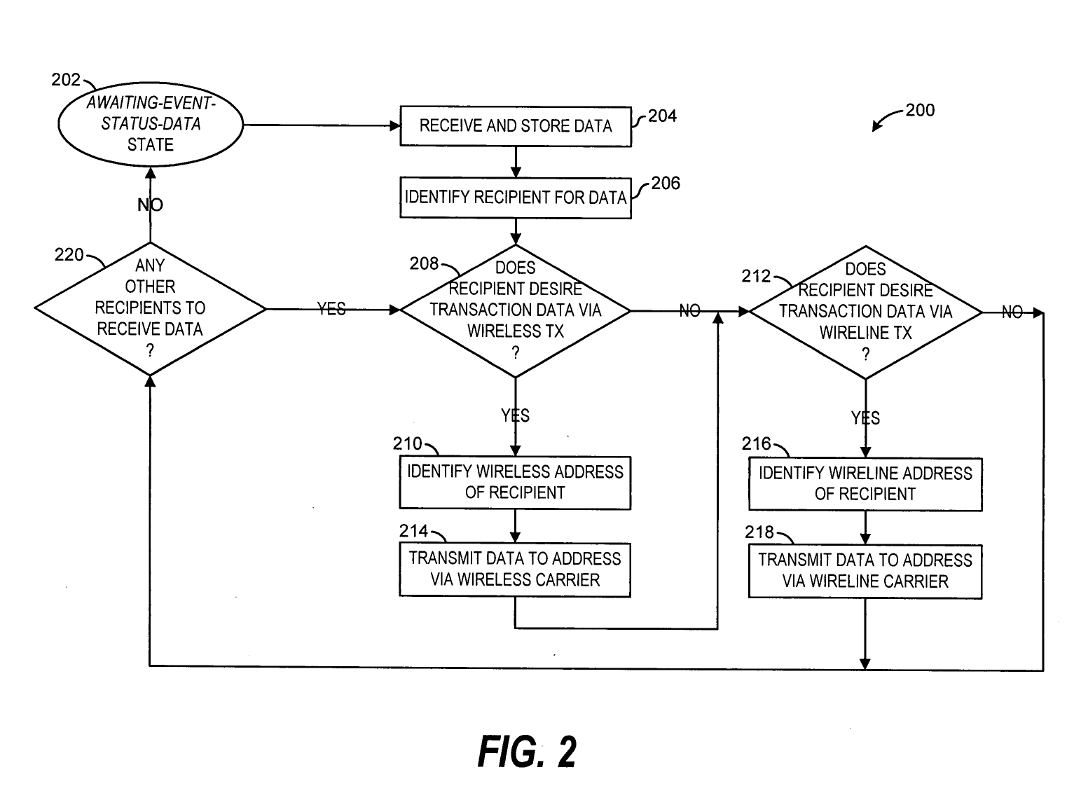

The financial institution 130 is an organization such as a bank, a clearing house, or the like, at which an account 132 is located, and which is effective for processing financial transactions made with the card 112 for the account 132. The financial institution 130 includes at least one electronic data processor 134, such as a conventional computer, connected in a conventional manner, such as through a data communication network, for receiving from the data processor 124 of the merchant 120, account 132 information, such as the number of the account 132 embedded on the commerce card 112, the amount of money transacted with the card, merchant information, and the like, necessary for processing the transaction. The data processor 134 may be a conventional computer comprising conventional memory components (not shown) effective for storing computer program code, described further below with respect to FIG. 2, executable by the data processor 134 for processing the received account 132 information.

The communications network 140 comprises a conventional network such as a telephone or Internet network effective for selectively sending signals through a wireless transmitter 142 and through a wireline transmitter 144. Communications networks are considered to be well known in the art and will therefore not be described in further detail herein.

The account owner 150 is the owner of the card 112 held by the card holder 110. The account owner 150 preferably possesses a wireless receiver 152 for receiving signals sent from the wireless transmitter 142, and a wireline receiver 154 for receiving signals sent from the wireline transmitter 144. The wireless receiver may be one of a text pager, a data-capable wireless telephone, a wireless personal digital assistant (PDA), or the like, effective for receiving wireless signals, such as pages, short message service (SMS) functions, or the like. The wireline receiver 154 may be a modem, computer, or the like, effective for receiving signals, such as electronic mail (e-mail) or voicemail, from an Internet connection, a telephone line, or the like. The receivers 152 and 154 are preferably connected for sending to at least one electronic data processor 156 (only one of which is shown) signals received from the transmitters 142 and 144, respectively. The data processor 156 may include application software effective for accumulating, manipulating, and generally processing the received signals and providing from the signals information presentable for review, e.g., in an electronic spreadsheet format, to the account owner 150 via an output device (not shown), such as a video display monitor, printer, or the like. The data processor 156 may optionally be integrated with the wireless receiver 152 and/or wireline receiver 154.

In operation, the card holder 110 physically hands the card 112 to the merchant 120 who runs the card through the card reader 122. The card reader 122 reads the card number and any other necessary data, such as expiration date of the card, and sends the read data to the data processor 124. The data processor 124 sends the read data to the data processor 134 of the financial institution 130. The data processor 134 then processes the data, as discussed below with respect to FIG. 2, and then sends at least a portion of the data to the communications network 140, with instructions on where to send the portion of the data via wireless and/or wireline transmission. The communications network 140 then sends the portion of data to the wireless receiver 152 and/or wireline receiver 154 of the account owner 150 via the wireless and/or wireline transmission, respectively, as instructed by the data processor 134. The wireless receiver 152 and/or wireline receiver 154 then transfer the data to the data processor 156 for processing in a conventional manner as programmed to do.

FIG. 2 depicts a flowchart 200 of computer program code implemented by the data processor 134 for forwarding data to the communications network 140 in accordance with the present invention. Step 202 represents an AWAITING-EVENT-STATUS-DATA state in which the financial institution data processor 134 is awaiting data from the merchant data processor 124. Such data would preferably include, at a minimum, the number of the card 112 and the amount of money transacted and, optionally, other information about the transaction, such as who the merchant is, and the like. Upon receiving such data, execution proceeds to step 204.

In step 204, the data received in step 202 is received and stored in a memory storage unit (not shown) of the data processor 134, such as random access memory, disk memory, or the like, in a conventional manner. In step 206, the data processor 134 identifies a recipient to whom the received data is to be sent. For the sake of illustration, the recipient will be deemed herein to the account owner 150. Step 206 may be performed in a conventional manner, such as by using a look-up table (not shown) that correlates the number of the card 112 with the account owner 150.

In step 208, a determination is made whether the recipient identified in step 206 has indicated a desire to be notified via wireless communications of the transaction reported in step 202. This may be performed in a conventional manner, such as in step 206, by the data processor 134 using a look-up table wherein a flag may be set to indicate that the data received in step 202 should be sent via wireless transmission to the account owner 150. If it is determined that the data should be sent to via wireless transmission to the account owner 150, then execution proceeds to step 210; otherwise, execution proceeds to step 212, discussed below.

In step 210, the data processor 134 identifies, e.g., from a look-up table, the address, e.g., phone number or e-mail address, of the wireless receiver 152 of the account owner 150. In step 214, the identified address and data is forwarded to the communications network 140 for transmission to the account owner 150. Execution then proceeds to step 212.

In step 212, a determination is made whether the recipient identified in step 206 has indicated a desire to be notified via wireline communications of the transaction reported in step 202. This may be performed in a conventional manner, such as in step 206, by the data processor 134 using a look-up table wherein a flag may be set to indicate that the data received in step 202 should be sent via wireline transmission to the account owner 150. If it is determined that the data should be sent to via wireline transmission to the account owner 150, then execution proceeds to step 216; otherwise, execution proceeds to step 220, discussed below.

In step 216, the data processor 134 identifies, e.g., from a look-up table, the address, e.g., phone number, of the wireline receiver 154 of the account owner 150. In step 218, the identified wireline address and data is forwarded to the communications network 140 for transmission to the account owner 150. Execution then proceeds to step 220.

In step 220, a determination is made whether there are any other recipients that should receive the data received in step 202 that have not received it thus far. This may be performed by the data processor 134 using a look-up table as in step 206. If it is determined that there is another recipient to whom the data should be sent, execution returns to step 208; otherwise, execution returns to step 202.

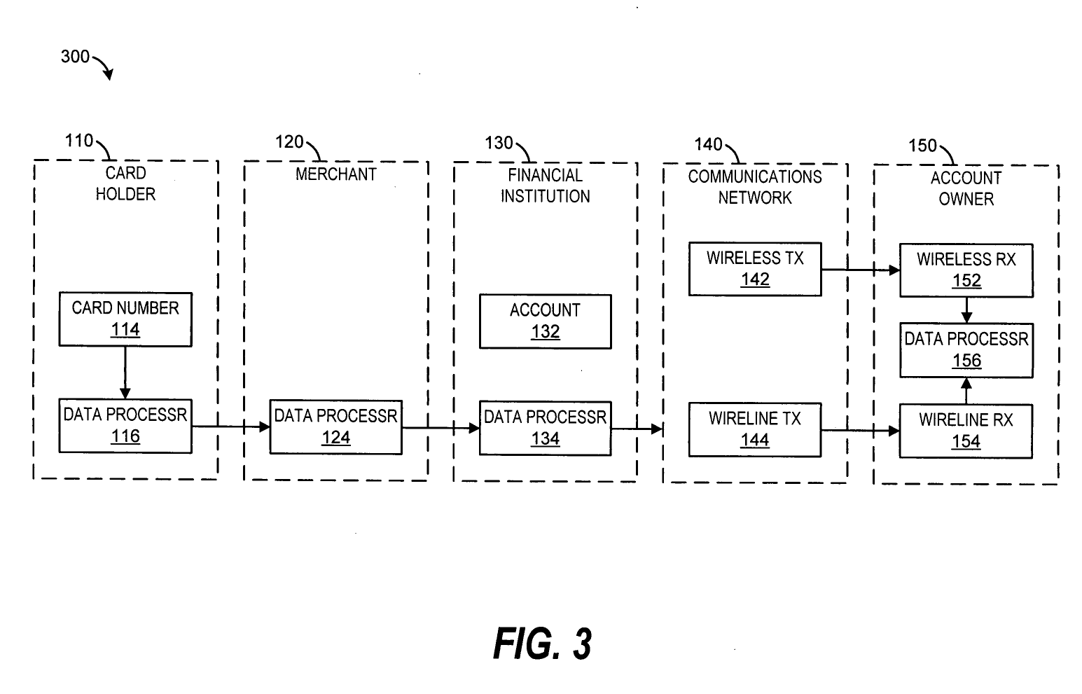

FIG. 3 depicts an alternate embodiment to the present invention, similar to FIG. 1, but adapted for use in electronic commerce (e-commerce), such as over the Internet. To that end, after the card holder 110 has ordered merchandise from the merchant 120, he enters relevant card data, such as the card number 114, of the card 112 (FIG. 1) into an electronic data processor 116, such as a conventional computer, in any conventional manner, such as via a keyboard. The data processor 116 is electronically coupled for delivering the card number electronically, such as through the Internet, to the data processor 124 of the merchant 120. The system and operation of the embodiment of FIG. 3 is, otherwise, similar to the embodiment of FIG. 1.

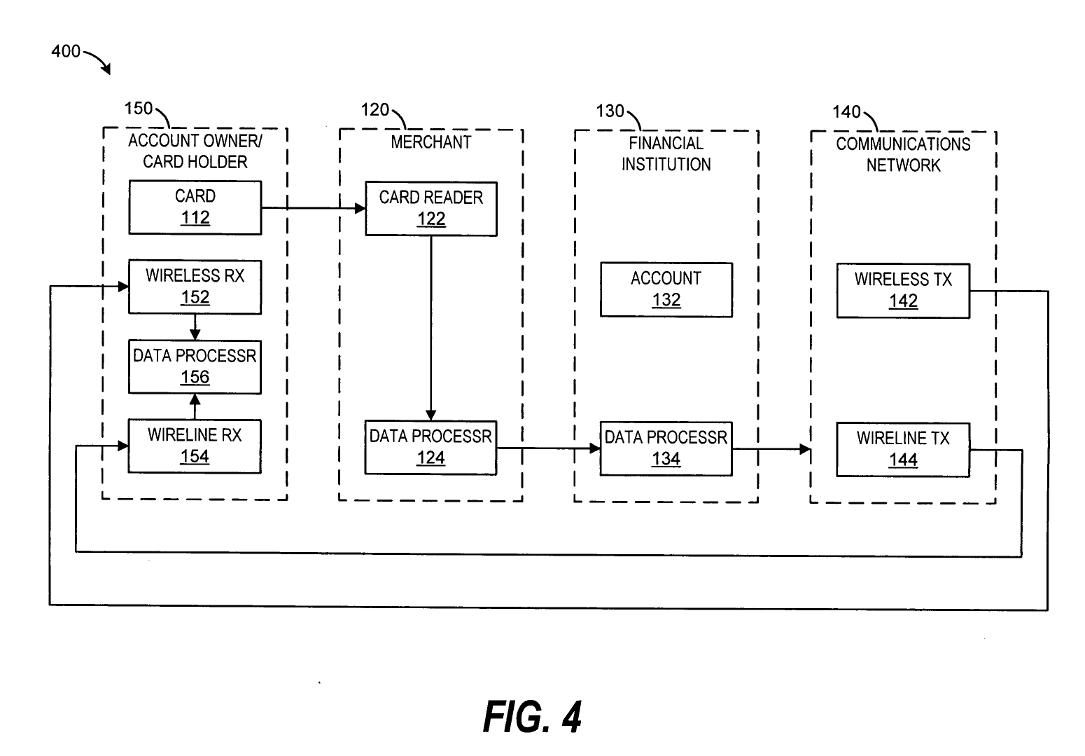

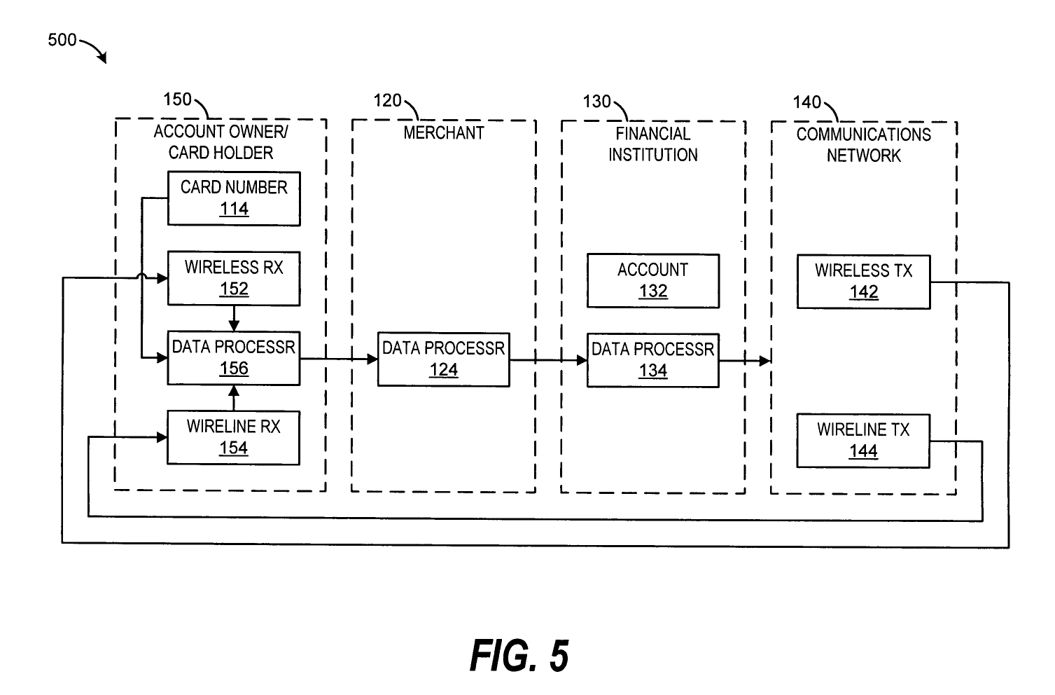

FIGS. 4 and 5 depict alternate embodiments to the present invention similar to the previous embodiments shown in FIGS. 1 and 3, respectively, but adapted for the case when the account owner 150 is also the holder of the card 112. To that end, the account owner 150 is shown in FIG. 4 as possessing the card 112, in addition to the wireless receiver 152, wireline receiver 154, and data processor 156. The system and operation of the embodiment of FIGS. 4 and 5 is, otherwise, similar to the embodiment of FIGS. 1 and 3, respectively.

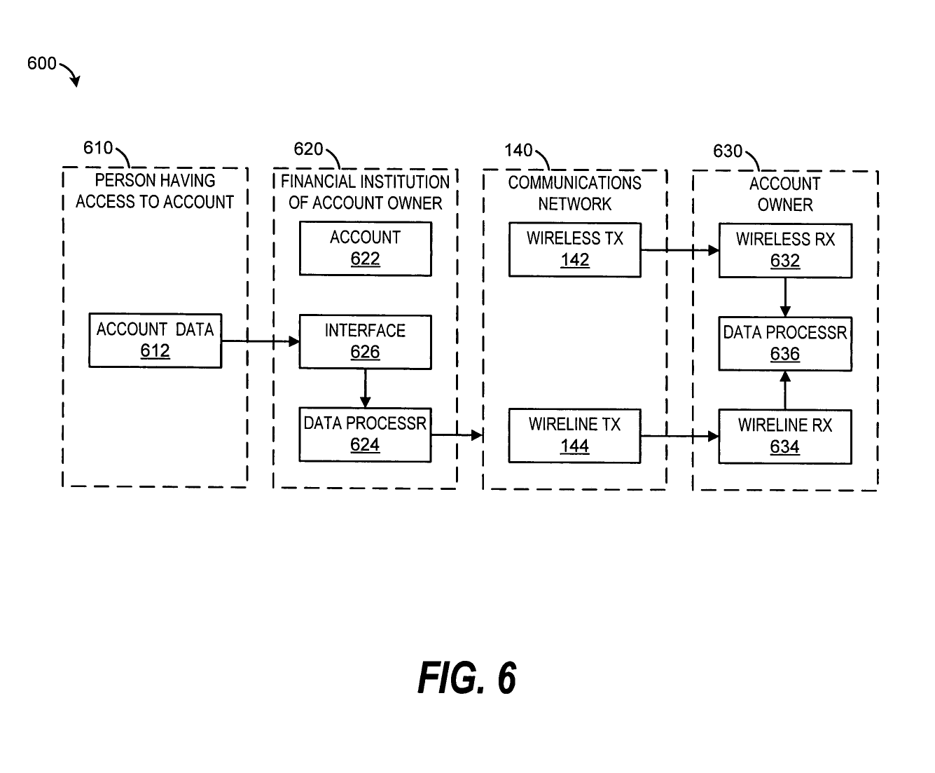

FIGS. 6-9 depict alternate embodiments of the present invention similar to the previous embodiments shown in FIGS. 1-5, respectively, but adapted for an owner of an account at a financial institution who deals directly with the financial institution, rather than indirectly through a merchant who deals with the financial institution.

Referring to FIG. 6 of the drawings, the reference numeral 600 generally designates a system comprising the communications network 140 discussed above, as well as a person 610 having access to an account 622 located at a financial institution 620 of an account owner 630.

The person 610 is a person or organization who has access, which may or may not be authorized, to the account 622 at the financial institution 620 to, for example, make deposits to the account, withdraw funds from the account, or initiate fund transferals to or from the account. Persons 610 having authorized access may include persons such as a family member (e.g., spouse or child of the account owner 630), a business associate of the account owner 630, or the like. For the sake of illustration herein, it is assumed that the person 610 possesses account data 612 of the account 622 at the financial institution 620, which account data 612 is sufficient to enable the person 610 to gain access to the account 622. The account data 612 may be human readable or machine readable, e.g., it may be a bar code, magnetic code, or the like. The account data may, for example, be encoded on a bank check, a bank draft, an Automated Teller Machine (ATM) card, and the like, drawn on the account 622. It is understood, though, that additional credentials may be required, such as a password, personal identification such as a credible photograph, and/or the like.

The financial institution 620 of the account owner 630 may be a bank, a brokerage firm, or the like, which offers at least one account 622 for securing, transferring, exchanging, and the like, financial instruments, such as money, stocks, bonds, and/or the like, for the account owner 630. The financial institution 620 also includes at least one electronic data processor 624, such as a conventional computer. The data processor 624 includes conventional memory components (not shown) effective for storing computer program code executable by the data processor 624 for receiving through an interface 626 the account data 612 from the person 610, and for processing the account data 612, as described further below with respect to FIG. 2. The interface 626 may be a person or a machine (e.g., a card reader) which may receive the account data 612 from the person 610, and transfer the data 612 to the data processor 624.

The account owner 630 owns the account 622 at the financial institution 620, and may be, for example, a trader and/or investor of stocks and bonds, an individual or corporate bank account holder, or the like. The account owner 630 preferably possesses a wireless receiver 632 for receiving signals sent from the wireless transmitter 142, and a wireline receiver 634 for receiving signals sent from the wireline transmitter 144. The wireless receiver 632 may be one of a text pager, a data-capable wireless telephone, a wireless personal digital assistant (PDA), or the like, effective for receiving wireless signals, such as pages, short message service (SMS) functions, or the like. The wireline receiver 634 may be a modem, computer, or the like, effective for receiving signals, such as e-mail or voicemail, from an Internet connection, a telephone line, or the like. The receivers 632 and 634 are preferably connected for sending to at least one electronic data processor 636 (only one of which is shown) data signals received from the transmitters 142 and 144, respectively. The data processor 636 may include application software effective for accumulating, manipulating, and generally processing the received signals and providing from the signals information presentable for review, e.g., in an electronic spreadsheet format, to the account owner 630 via an output device (not shown), such as a video display monitor, printer, or the like. The data processor 636 may optionally be integrated with the wireless receiver 632 and/or wireline receiver 634.

In operation, the person 610 gains access to the account 622 by conveying the account data 612 through the interface 626 to the data processor 624 at the financial institution 620. The interface 626 receives the account data and any other necessary data, such as proof of authorization to access the account 622, and sends the received data to the data processor 624. The data processor 624 then processes the data, as discussed below with respect to FIG. 2, and then sends at least a portion of the data to the communications network 140, with instructions directing where the portion of the data should be sent and by what mode, e.g., wireless and/or wireline transmission. The communications network 140 then sends the portion of data to the wireless receiver 632 and/or wireline receiver 634 of the account owner 630 via the wireless and/or wireline transmission, respectively, as instructed by the data processor 624. The wireless receiver 632 and/or wireline receiver 634 then transfer the data to the data processor 636 for processing in a conventional manner as programmed to do.

Referring again to FIG. 2, depicted is the flowchart 200 of computer program code adapted for implementation by the data processor 624 for forwarding data to the communications network 140 in accordance with the present invention. Step 202 represents an AWAITING-EVENT-STATUS-DATA state in which the financial institution 620 data processor 624 is awaiting account data 612 from the person 610 via the interface 626. Such data would preferably include, at a minimum, the number of the account 622 and the amount of money, stocks, bonds, or the like, transacted. Upon receiving such data, execution proceeds to step 204.

In step 204, the data received in step 202 is stored in a memory storage unit (not shown) of the data processor 624, such as random access memory, disk memory, or the like, in a conventional manner. In step 206, the data processor 624 identifies a recipient to whom the received data is to be sent. For the sake of illustration, the recipient will be deemed herein to the account owner 630. Step 206 may be performed in a conventional manner, such as by using a look-up table (not shown) that correlates the number of the account 612 with the account owner 630.

In step 208, a determination is made whether the recipient identified in step 206 has indicated a desire to be notified via wireless communications of the transaction reported in step 202. This may be performed in a conventional manner, such as in step 206, by the data processor 624 using a look-up table wherein a flag may be set to indicate that the data received in step 202 should be sent via wireless transmission to the recipient. If it is determined that the data should be sent via wireless transmission to the account owner 630, then execution proceeds to step 210; otherwise, execution proceeds to step 212, discussed below.

In step 210, the data processor 624 identifies, e.g., from a look-up table, the address, e.g., phone number or e-mail address, of the wireless receiver 632 of the account owner 630. In step 214, the identified address and data is forwarded to the communications network 140 for transmission to the account owner 630. Execution then proceeds to step 212.

In step 212, a determination is made whether the recipient identified in step 206 has indicated a desire to be notified via wireline communications of the transaction reported in step 202. This may be performed in a conventional manner, such as in step 206, by the data processor 624 using a look-up table wherein a flag may be set to indicate that the data received in step 202 should be sent via wireline transmission to the account owner 630. If it is determined that the data should be sent via wireline transmission to the account owner 630, then execution proceeds to step 216; otherwise, execution proceeds to step 220, discussed below.

In step 216, the data processor 624 identifies, e.g., from a look-up table, the address, e.g., phone number, of the wireline receiver 634 of the account owner 630. In step 218, the identified wireline address and data is forwarded to the communications network 140 for transmission to the account owner 630. Execution then proceeds to step 220.

In step 220, a determination is made whether there are any other recipients that should receive the data received in step 202 that have not received it thus far. This may be performed by the data processor 624 using a look-up table as in step 206. If it is determined that there is another recipient to whom the data should be sent, execution returns to step 208; otherwise, execution returns to step 202.

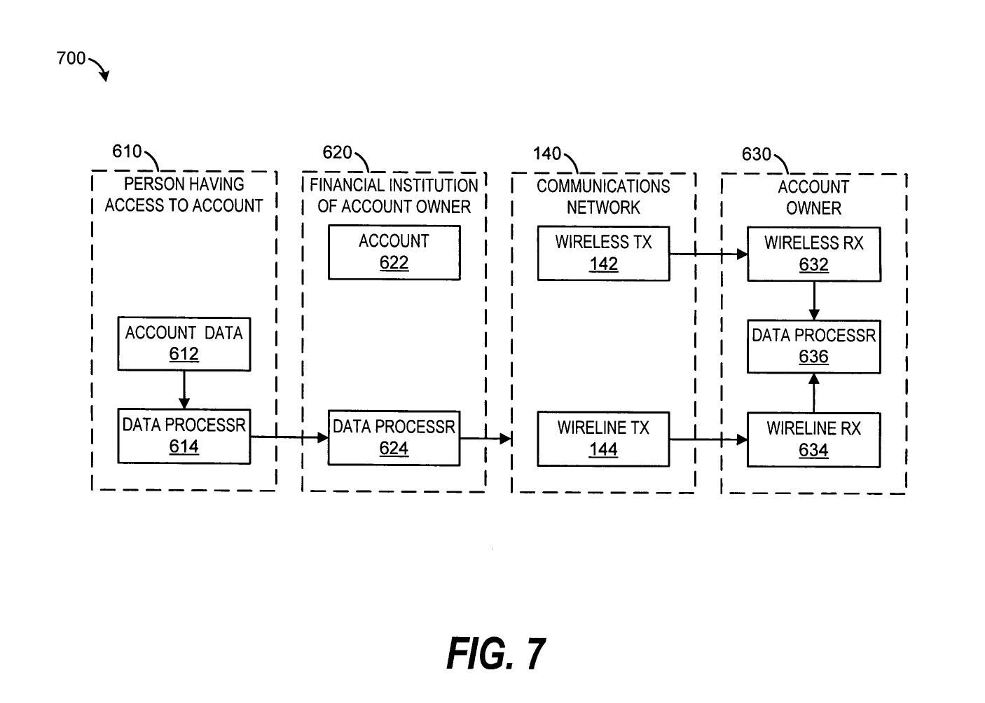

FIG. 7 depicts an alternate embodiment to the present invention, similar to FIG. 6, but adapted for use in electronic commerce (e-commerce), such as over the Internet. To that end, the person 610 is provided with an electronic data processor 614 electronically coupled, e.g., via the Internet, to the data processor 624 of the financial institution 620 for data communication therebetween. The person 610 enters the account data 612 into the data processor 614 in any conventional manner, such as via a keyboard. The data processor 614 then sends the data to the data processor 624. The system and operation of the embodiment of FIG. 7 is, otherwise, similar to the embodiment of FIG. 6, described above.

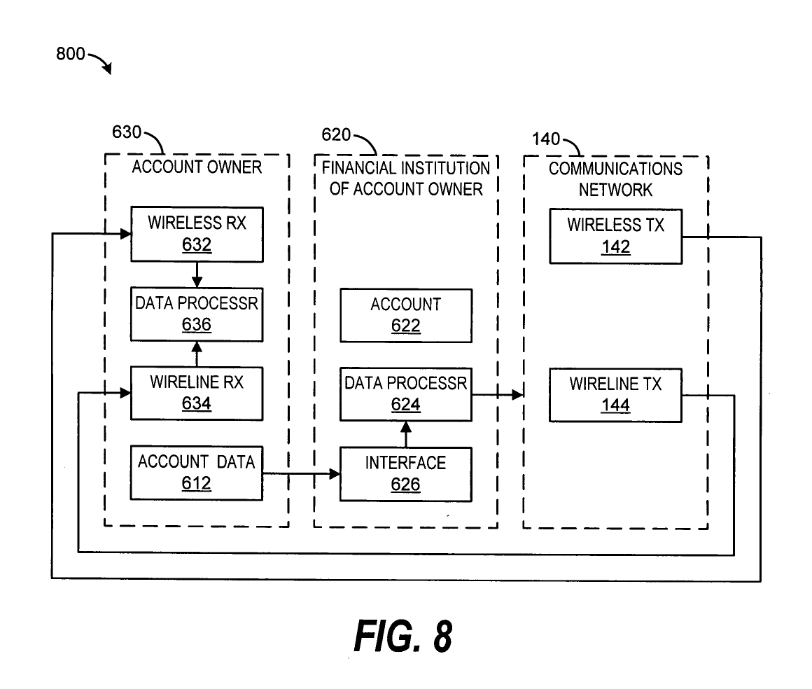

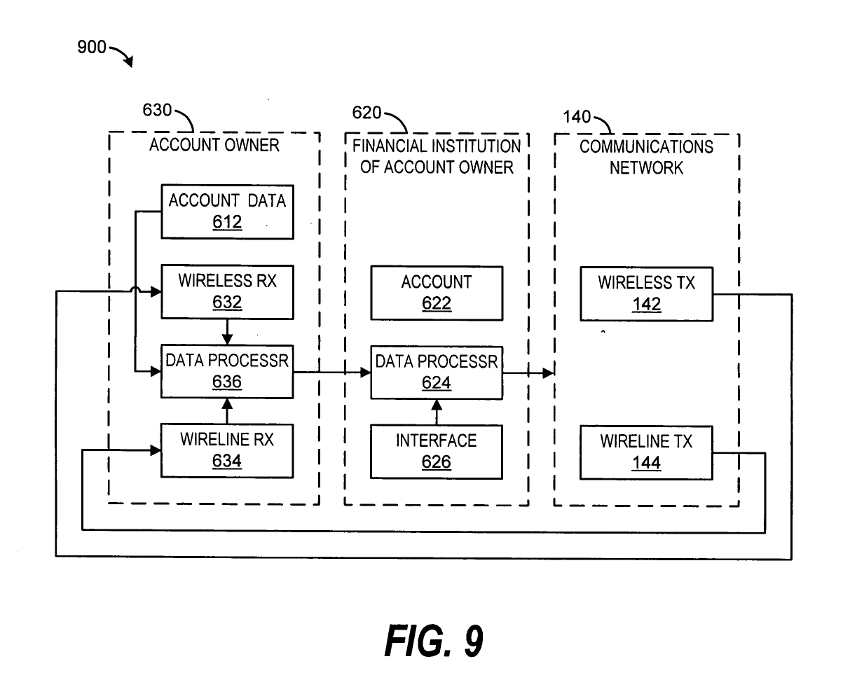

FIGS. 8 and 9 depict alternate embodiments of the present invention similar to the previous embodiments shown in FIGS. 6 and 7, respectively, but adapted for the case when the account owner 150 is also the person accessing the account. To that end, the account owner 630 is shown in FIG. 8 as possessing the account data 612, in addition to the wireless receiver 632, wireline receiver 634, and data processor 636. The system and operation of the embodiment of FIGS. 8 and 9 is, otherwise, similar to the embodiment of FIGS. 6 and 7, respectively.

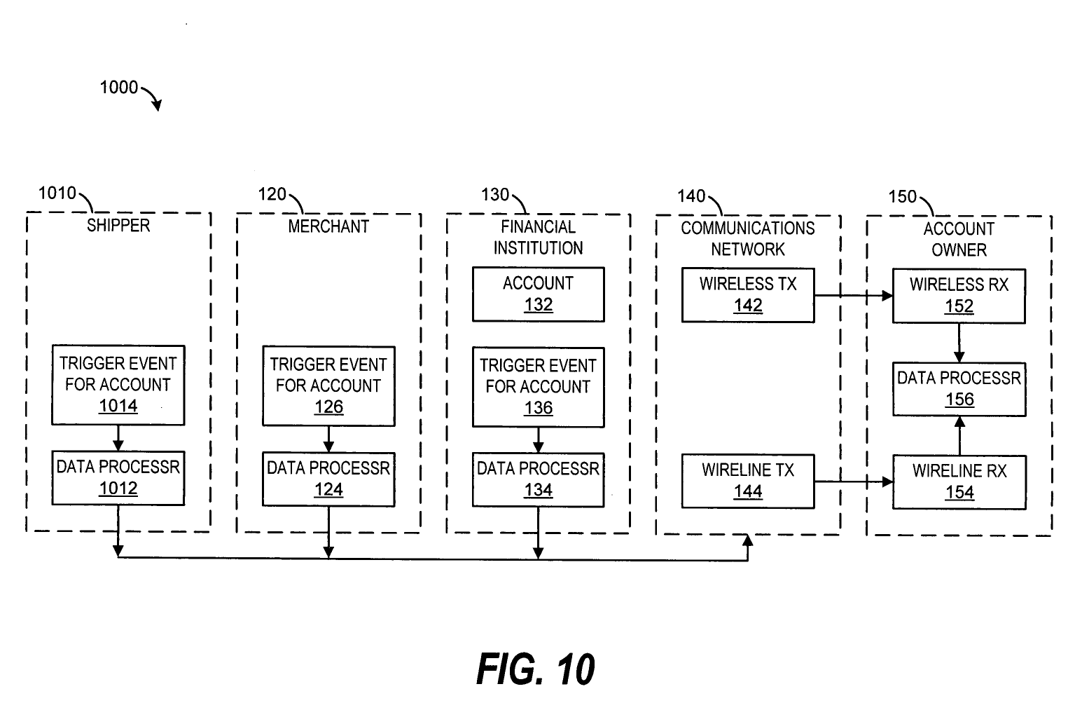

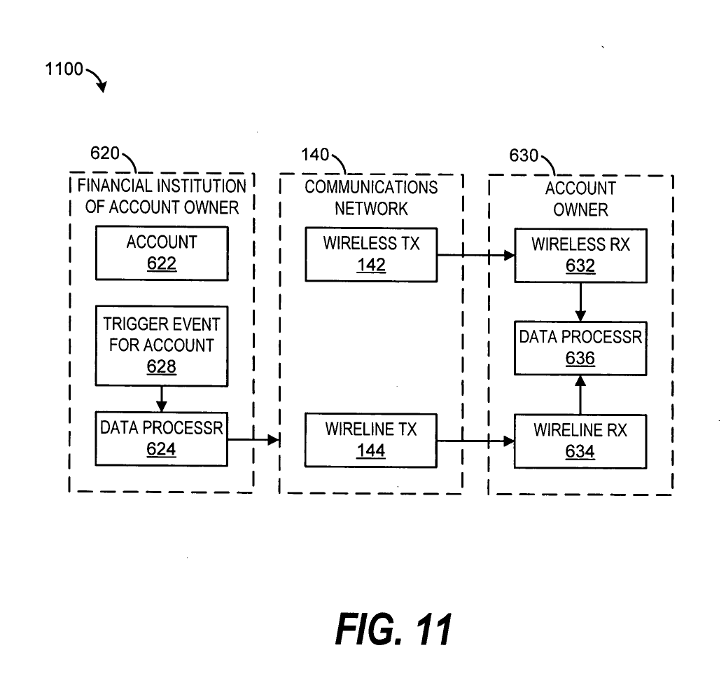

FIGS. 10 and 11 depict alternate embodiments of the present invention similar to the previous embodiments shown in FIGS. 1-9, respectively, but adapted for events generated internally by the merchant or within the financial institution that are generally indicative of the status of a process that would be desirable by an account owner to be aware of.

Referring to FIG. 10 of the drawings, the reference numeral 1000 generally designates a system comprising the merchant 120, the communications network 140, and the account owner 150, discussed above with respect to FIG. 1, and in addition, a shipper 1010. The shipper 1010 includes at least one electronic data processor 1012, such as a conventional computer, and may be any conventional shipper effective for shipping merchandise ordered by the card holder 110 in FIG. 1 or 3, or by the account owner 150 in FIG. 4 or 5.

In addition to what was discussed above with respect to FIG. 1, the merchant 120, financial institution 130, and shipper 1010 also include a trigger mechanisms 126, 136, and 1014, respectively, which, when triggered by a specified event, generate a signal indicative of the event to a respective data processor 124, 134, or 1012, respectively. Events which may activate the trigger mechanism 126, 136, or 1014 include events which occur internally to the merchant 120, financial institution 130, or shipper 1010, respectively, or to entities affiliated therewith, which trigger events may be specified by the account owner 150 to the respective merchant, financial institution, or shipper. Specifically, the trigger mechanism 126 may be activated by such events as, for example, the execution or delays of a purchase order for merchandise made by the card holder 110 in FIG. 1 or 3, or by the account owner 150 in FIG. 4 or 5. The financial institution trigger mechanism 136 may be activated by such events as, for example, insufficient funds in the account 132 which may prevent execution or shipment of such purchase order. The shipper trigger mechanism 1014 may be activated by such events as, for example, execution or delays of shipment of purchase order merchandise made by the card holder 110 in FIG. 1 or 3, or by the account owner 150 in FIG. 4 or 5.

Upon the occurrence of an event which activates the trigger mechanism 126, 136, or 1014, a signal is generated by the trigger mechanism to a respective data processor 124, 134, or 1012, which then processes the signal in accordance with the steps depicted in the flow chart 200 described above with respect to FIG. 2. The system and operation of the embodiment of FIG. 10 is, otherwise, similar to the embodiment of FIGS. 1 and 3-5.

Referring to FIG. 11 of the drawings, the reference numeral 1100 generally designates a system comprising the financial institution 620, the communications network 140, and the account owner 630, discussed above with respect to FIGS. 6-9.

In addition to what was discussed above with respect to FIG. 1, the financial institution 130 also includes a trigger mechanism 628 which, when triggered by a specified event, generates a signal indicative of the event to the data processor 624. Events which may activate the trigger mechanism 628 include events which occur internally to the financial institution 130, or to entities affiliated therewith, which trigger events may be specified by the account owner 150 to the financial institution. Specifically, if the financial institution is a brokerage firm, the trigger mechanism 628 may be activated by such events as, for example, the generation of requested stock quotes, or the execution or delays of a purchase, sell, or trade of financial instruments such as stocks and/or bonds, by the person 610 having access to the account 622 in FIGS. 6 and 7, or by the account owner shown in FIGS. 8 and 9. If the financial institution is a bank, the trigger mechanism 628 may be activated by such events as, for example, the entry, clearing, or bouncing (e.g., from insufficient funds in the account 622) of a bank draft or check executed by the person 610 having access to the account 622 in FIGS. 6 and 7, or by the account owner shown in FIGS. 8 and 9.

Upon the occurrence of an event which activates the trigger mechanism 628, a signal is generated by the trigger mechanism to the data processor 624, which then processes the signal in accordance with the steps depicted in the flow chart 200 described above with respect to FIG. 2. The system and operation of the embodiment of FIG. 11 is, otherwise, similar to the embodiment of FIGS. 1 and 3-5.

By the use of the present invention, fraud in the use of commerce cards may be detected as soon as such fraud is committed. Legitimate use of commerce cards by others (such as children) may also be monitored. An account owner may monitor deposits, withdrawals, and fund transferals made or from the account. An account owner may also be kept up to date on the status of merchandise orders (particularly of e-commerce orders) and also monitor stock trades and quotes. The accuracy of transactions may be readily confirmed. The foregoing provide consumers with a greater sense of control and awareness over his financial status, and assist in managing and tracking personal finances.

It is understood that the present invention can take many forms and embodiments. Accordingly, several variations may be made in the foregoing without departing from the spirit or the scope of the invention. For example, information transmitted via the communications network may be prioritized to assist a recipient in reviewing the information.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1-33. (canceled)

34. A method comprising the steps of:
detecting that a transaction has been conducted using a user's account;
determining if the user desires notification of the transaction via a wireless device and if so,
sending selected information relating to the transaction to the user via the desired wireless device;
determining if the user desires notification of the transaction via a wireline device and if so, sending the selected information relating to the transaction to the wireline device.

35. A method for alerting a credit card user to possible fraudulent use of a credit card comprising the steps of:
detecting that a financial transaction has been conducted using the user's credit card account;
determining if the user desires notification of the transaction via a wireless device and if so,
sending selected information relating to the transaction to the user via the desired wireless device;
determining if the user desires notification of the transaction via a wireline device and if so, sending the selected information relating to the transaction to the wireline device, whereby the user receives timely notification of a transaction utilizing his/her credit card thereby alerting the user of possible unauthorized use if the selected information received concerning the transaction does not seem proper to the user.

36. The method of claim 34 wherein said detecting, determining and sending steps are performed by at least one electronic data processor.

37. A method comprising the steps of:
receiving data indicating that a transaction has been conducted using a user's account;
determining if the user desires notification of the transaction via a wireless device and if so,
sending selected data relating to the transaction to the user via the desired wireless device;
determining if the user desires notification of the transaction via a wireline device and if so, sending the selected information relating to the transaction to the wireline device.

38. The method of claim 37 wherein said receiving further comprises receiving data from one of a merchant, a card holder, an account owner, or an entity having access to the account.

39. The method of claim 37 wherein said selected data comprises data depicting the amount of money involved in the transaction.

40. The method of claim 37 wherein the transaction involves one of a credit card transaction, a debit card transaction, a long distance calling card transaction, or an automated teller machine transaction.

41. The method of claim 40 wherein the transaction involves one of a credit card transaction, a debit card transaction, a long distance calling card transaction, and an automated teller machine transaction.

42. The method of claim 37 wherein said selected data comprises data depicting the amount of money involved in the transaction with one of a merchant, a service provider, a bank, an automated teller machine, and a brokerage firm.

43. The method of claim 37 wherein the selected data comprises data generated by a trigger mechanism activated by one of the execution of a purchase order for merchandise, the delay of a purchase order for merchandise, the execution of a shipment of purchase order merchandise, the delay of a shipment of purchase order merchandise, insufficient funds in an account, the generation of requested stock quotes, execution of a purchase, sell, or trade of at least one financial instrument, the delay of a purchase, sell, or trade of at least one financial instrument, the entry of a bank draft or bank check, and the clearing of a bank draft or check.

44. The method of claim 37 wherein the wireless device comprises one of a text pager, data-capable wireless telephone, and a wireless personal digital assistant (PDA).

45. The method of claim 37 wherein said selected data comprises at least one of a page, a text message, a short message service (SMS) function, an e-mail, and a voicemail.

46. The method of claim 37 wherein the wireless device comprises application software configured for processing the at least a portion of said data.

47. The method of claim 37 wherein the wireless device is configured for presenting the at least a portion of said data to one of an account owner, an investor, a stock trader, a bank account holder, and a purchaser of merchandise.

48. The method of claim 37 wherein the step of determining if the user desires notification of the transaction via a wireless device is performed using a look-up table which correlates at least one wireless device to the at least a portion of said transaction data.

49. The method of claim 34 wherein said detecting further comprises receiving data from one of a merchant, a card holder, an account owner, or an entity having access to the account.

50. The method of claim 34 wherein said selected information comprises data depicting the amount of money involved in the transaction.

51. The method of claim 34 wherein the transaction involves one of a credit card transaction, a debit card transaction, a long distance calling card transaction, or an automated teller machine transaction.

52. The method of claim 51 wherein the transaction involves one of a credit card transaction, a debit card transaction, a long distance calling card transaction, and an automated teller machine transaction.

53. The method of claim 34 wherein said selected information comprises data depicting the amount of money involved in the transaction with one of a merchant, a service provider, a bank, an automated teller machine, and a brokerage firm.

54. The method of claim 34 wherein the selected information comprises data generated by a trigger mechanism activated by one of the execution of a purchase order for merchandise, the delay of a purchase order for merchandise, the execution of a shipment of purchase order merchandise, the delay of a shipment of purchase order merchandise, insufficient funds in an account, the generation of requested stock quotes, execution of a purchase, sell, or trade of at least one financial instrument, the delay of a purchase, sell, or trade of at least one financial instrument, the entry of a bank draft or bank check, and the clearing of a bank draft or check.

55. The method of claim 34 wherein the wireless device comprises one of a text pager, data-capable wireless telephone, and a wireless personal digital assistant (PDA).

56. The method of claim 34 wherein said selected information comprises at least one of a page, a text message, a short message service (SMS) function, an e-mail, and a voicemail.

57. The method of claim 34 wherein the wireless device comprises application software configured for processing the at least a portion of said data.

58. The method of claim 34 wherein the wireless device is configured for presenting the at least a portion of said data to one of an account owner, an investor, a stock trader, a bank account holder, and a purchaser of merchandise.

59. The method of claim 34 wherein the step of determining if the user desires notification of the transaction via a wireless device is performed using a look-up table which correlates at least one wireless device to the at least a portion of said transaction data.

60. A method of providing information relating to a transaction, comprising the steps of:
receiving information relating to transaction relevant to an end user;
determining whether such end users wishes to receive information relating to such transaction;
sending selected information relating to such transaction to an end user device of such user.

61. The method of claim 60, wherein such device is either a wireless device or a wireline device.

62. The method of claim 60, further comprising the step of determining whether such end user wishes to receive information relating to such transaction via an end user wireless device or an end user wireline device, and sending such selected information to such device.

63. The method of claim 60, wherein such selected information is send to both a wireless device and a wireline device of the end user.

64. The method of claim 60, where the transaction pertains a debit with respect the user's account.

65. The method of claim 60, where in the transaction pertains to the shipping of goods.

66. A system for providing information relating to a transaction, comprising:
a processor for receiving information relating to transaction relevant to an end user and determining whether such end users wishes to receive information relating to such transaction;
transmitter for transmitting information relating to such transaction to an end user device of such use if such end users wishes to receive information relating to such transaction.

67. The system of claim 66, wherein such transmitter is designed to provide wireless transmission of information relating to such transaction to a wireless end user device.

68. An end user device, comprising:
a receiver for receiving information relating to a transaction relevant to a user of such device;
a display mechanism for displaying such information to the user.
